(19) United States
(12) Patent Application Publication
(10) Pub. No.: US 2013/0262602 A1
(43) Pub. Date: Oct. 3, 2013

(54) COMPUTER-READABLE NON-TRANSITORY MEDIUM, CONTROL METHOD, AND CONTROL APPARATUS

(71) Applicant: FUJITSU LIMITED, Kawasaki-shi (JP)

(72) Inventors: Mitsuo KONDO, Yamato (JP); Hiroyuki FUKUMOTO, Numadu (JP)

(73) Assignee: FUJITSU LIMITED, Kawasaki-shi (JP)

(21) Appl. No.: 13/849,701

(22) Filed: Mar. 25, 2013

(30) Foreign Application Priority Data
Mar. 30, 2012 (JP) 2012-079544

(51) Int. Cl. H04L 12/58

(52) U.S. Cl. CPC H04L 51/063
USPC 709/206

(57) ABSTRACT

A computer-readable, non-transitory medium storing therein a control program that causes a computer to execute a procedure, the procedure comprises, receiving a first message from an information processing apparatus, searching for a second message in a storage unit in response to reception of the first message, the storage unit storing messages received from the information processing apparatus in a chronological order of the messages, the second message including a same content with the first message, comparing a third message that is stored in the storage unit prior to the first message with a fourth message that is stored in the storage unit prior to the second message, and specifying a processing performed in response to a reception of the second message, when the third message includes a same content with the fourth message, the processing being specified based on information associated with the second message stored in the storage unit.

### CROSS-REFERENCE TO RELATED APPLICATION(S)

This application is based upon and claims the benefit of priority of the prior Japanese Patent Application No. JP2012-079544, filed on Mar. 30, 2012, the entire contents of which are incorporated herein by reference.

### FIELD

The embodiment discussed herein is related to processing of received messages.

### BACKGROUND

During operation and management of a system, messages (pieces of information) that notify the system administrator of contents of various events that occur during operation of the system are output from an information processing apparatus included in the system. The system administrator receives the output messages, reads contents of the messages by using a terminal capable of outputting the messages, and checks the operation state of the system. Depending on the circumstances, the system administrator also finds out a problematic event from the contents of the messages and takes action against the event.

In the related art, a control apparatus that controls outputting of messages stores definition information, which describes how an output message is to be processed in a terminal in response to output of the message. Examples of processing that is set in the definition information include processing of displaying or not displaying the received message in the terminal. The control apparatus processes the received message in accordance with the corresponding definition information.

Also, there is provided a technique for generating definition information for executing processing, which has been executed for messages of the same kind that have been output, when a message, for which no definition information is stored in the control apparatus that controls outputting of messages, is newly output.

In operation and management of a system, it may be desirable to change contents of processing, such as whether or not to display a message, even for messages of the same kind depending on a relationship between this message and another output message. For example, when a message B is typically output after a message A is output, output of the message B is expected. Thus, the message B may be a redundant message in operation and management of the system. An increase in the number of redundant messages makes a work for reading the messages performed by the system administrator troublesome. Thus, when the message A is output, processing is desirably performed to avoid displaying the message B that is output after the message A is output.

On the other hand, when the message B is output without the message A, the message B is not redundant. Thus, the message B is desirably displayed.

In the related art, however, processing is performed in accordance with a message that is output this time regardless of the output state of another message.

### SUMMARY

According to an aspect of the invention, A computer-readable, non-transitory medium storing therein a control program that causes a computer to execute a procedure, the procedure comprising, receiving a first message from an information processing apparatus, searching for a second message in a storage unit in response to reception of the first message, the storage unit storing messages received from the information processing apparatus in a chronological order of the messages, the second message including a same content with a content of the first message, comparing a third message that is stored in the storage unit prior to the first message, with a fourth message that is stored in the storage unit prior to the second message, and specifying a processing performed in response to a reception of the second message, when the third message includes a same content with a content of the fourth message, the processing being specified based on information associated with the second message stored in the storage unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a hardware configuration of a system according to an embodiment;

FIG. 2 is a functional block diagram of a control apparatus;

FIG. 3 is a flowchart illustrating a procedure of a process executed by the control apparatus;

FIG. 4 illustrates an example of a data structure of a message that is output by a business server and is received by a transmission-reception unit;

FIG. 5 illustrates analysis results;

FIG. 6 illustrates extraction results;

FIG. 7 illustrates definition information;

FIG. 8 illustrates default definition information;

FIG. 9 is a flowchart illustrating a procedure of a process executed by a generation unit;

FIG. 10 illustrates definition information;

FIG. 11 illustrates messages; and

FIG. 12 illustrates analysis results.

### DESCRIPTION OF EMBODIMENT

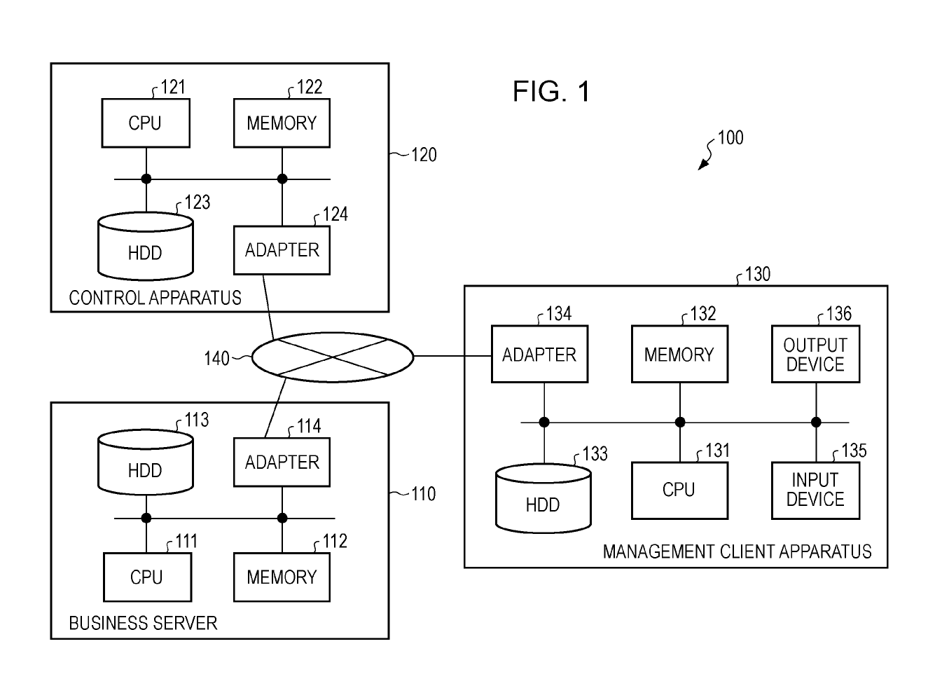

An embodiment (an example) will be described with reference to the accompanying drawings. FIG. 1 is a diagram illustrating a hardware configuration of a system 100 according to an embodiment. As illustrated in FIG. 1, the system 100 according to this embodiment includes a business server 110, a control apparatus 120, and a management client apparatus 130, which are connected to each other via a network 140, e.g., a local area network (LAN), so as to be able to perform communication with each other.

The business server 110 and the control apparatus 120 may be implemented by using, for example, server apparatuses. Also, the management client apparatus 130 may be implemented by using, for example, a personal computer (PC).

Description of Hardware

The business server 110 executes an application that performs processes in the system 100. The business server 110 includes a central processing unit (CPU) 111, a memory 112, a hard disk drive (HDD) 113, and an adapter 114, which are connected to each other via a bus so as to be able to communicate with each other.

The CPU 111 executes computation processing or the like in the business server 110. The memory 112 and the HDD 113 store information used in processing executed by the business server 110, such as application programs executed by the CPU 111, for example. A storage device of another kind, e.g., a semiconductor storage device, may be used instead of the HDD 113. The adapter 114 is an adapter that connects the business server 110 to the network 140. For example, when the network 140 is a LAN, a LAN adapter may be used.

The control apparatus 120 executes processing for a message that is output by the business server 110 during execution of the application. The control apparatus 120 also generates definition information that defines contents of the processing. The control apparatus 120 includes a CPU 121, a memory 122, an HDD 123, and an adapter 124, which are connected to each other via a bus so as to be able to communicate with each other.

The CPU 121 executes computation processing or the like in the control apparatus 120. The memory 122 and the HDD 123 store information used in processing executed by the control apparatus 120, such as programs executed by the CPU 121, for example. A storage device of another kind, e.g., a semiconductor storage device, may be used instead of the HDD 123. The adapter 124 is an adapter (interface) that connects the control apparatus 120 to the network 140. For example, when the network 140 is a LAN, a LAN adapter may be used.

The management client apparatus 130 is an apparatus that executes processing for a message that is output by the business server 110 during execution of the application. The management client apparatus 130 includes a CPU 131, a memory 132, an HDD 133, an adapter 134, an input device 135, and an output device 136, which are connected to each other via a bus so as to be able to communicate with each other.

The CPU 131 executes computation processing or the like in the management client apparatus 130. The memory 132 and the HDD 133 store information used in processing executed by the management client apparatus 130, such as programs executed by the CPU 131, for example. A storage device of another kind, e.g., a semiconductor storage device, may be used instead of the HDD 133. The adapter 134 is an adapter that connects the management client apparatus 130 to the network 140. For example, when the network 140 is a LAN, a LAN adapter may be used. The input device 135, e.g., a keyboard or a mouse, is used by the operation administrator or the like to perform an input operation on the business server 110 or the control apparatus 120. The output device 136 may be, for example, a display that displays a message output by the business server 110.

Each of the business server 110 and the control apparatus 120 may include an input device and an output device.

In this embodiment, the business server 110 and the control apparatus 120 are implemented as different pieces of hardware as illustrated in FIG. 1. However, for example, the processing executed by the control apparatus 120 and the processing executed by the business server 110 may be executed by one server apparatus. Also, for example, the business server 110 may be implemented by a plurality of server apparatuses. Similarly, the control apparatus 120 may be implemented by a plurality of server apparatuses. By implementing the business server 110 and the control apparatus 120 by using different pieces of hardware, a load of processing executed in the system 100 may be distributed, for example.

Functional Block Diagram

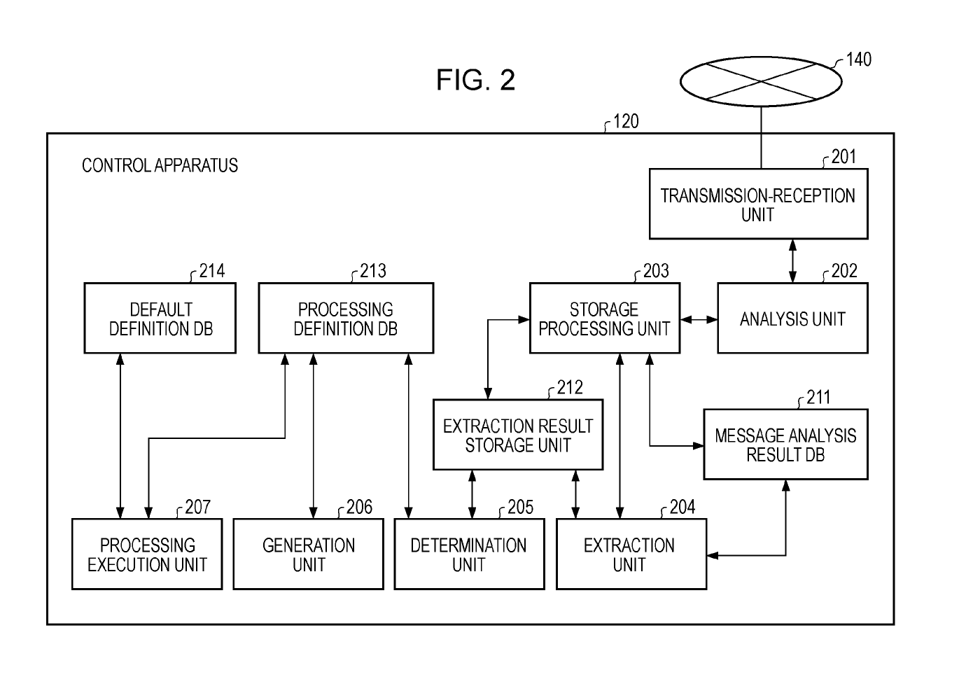

FIG. 2 is a functional block diagram of the control apparatus 120. As functional units, the control apparatus 120 includes a transmission-reception unit 201, an analysis unit 202, a storage processing unit 203, an extraction unit 204, a determination unit 205, a generation unit 206, and a processing execution unit 207. The control apparatus 120 also includes a message analysis result database (hereinafter, abbreviated as DB) 211, an extraction result storage unit 212, a processing definition DB 213, and a default definition DB 214.

The transmission-reception unit 201 receives a message output by the business server 110. The analysis unit 202 analyzes the message received by the transmission-reception unit 201 and identifies various pieces of information contained in the message. The storage processing unit 203 stores, after determination processing described later completes, the analysis result obtained by the analysis unit 202 in the message analysis result DB 211. The extraction unit 204 extracts analysis results of messages from the message analysis result DB 211. The determination unit 205 determines whether or not processing is set (defined) for the message received by the transmission-reception unit 201. The generation unit 206 executes a process of setting (defining) processing for the message received by the transmission-reception unit 201. The processing execution unit 207 executes processing that is set for the message received by the transmission-reception unit 201 (processing that is set in the processing definition DB 213).

The message analysis result DB 211 stores analysis results of messages that are received by the transmission-reception unit 201 and are analyzed by the analysis unit 202. The extraction result storage unit 212 stores messages that are extracted by the extraction unit 204 from the message analysis result DB 211. The processing definition DB 213 stores information (definition information) that defines processing for a message and is generated as a result of the process executed by the generation unit 206. The default definition DB 214 stores, for each kind of message, information that is set in advance by the administrator of the system 100, for example.

The analysis unit 202, the storage processing unit 203, the extraction unit 204, the determination unit 205, the generation unit 206, and the processing execution unit 207 may be implemented, for example, by the CPU 121 by executing programs stored in the HDD 123. Also, as the transmission-reception unit 201, an interface unit, such as the adapter 124, for example, may be used. Moreover, the message analysis result DB 211, the extraction result storage unit 212, the processing definition DB 213, and the default definition DB 214 may be implemented by using the HDD 123 or the memory 122.

Description of Processing Flow

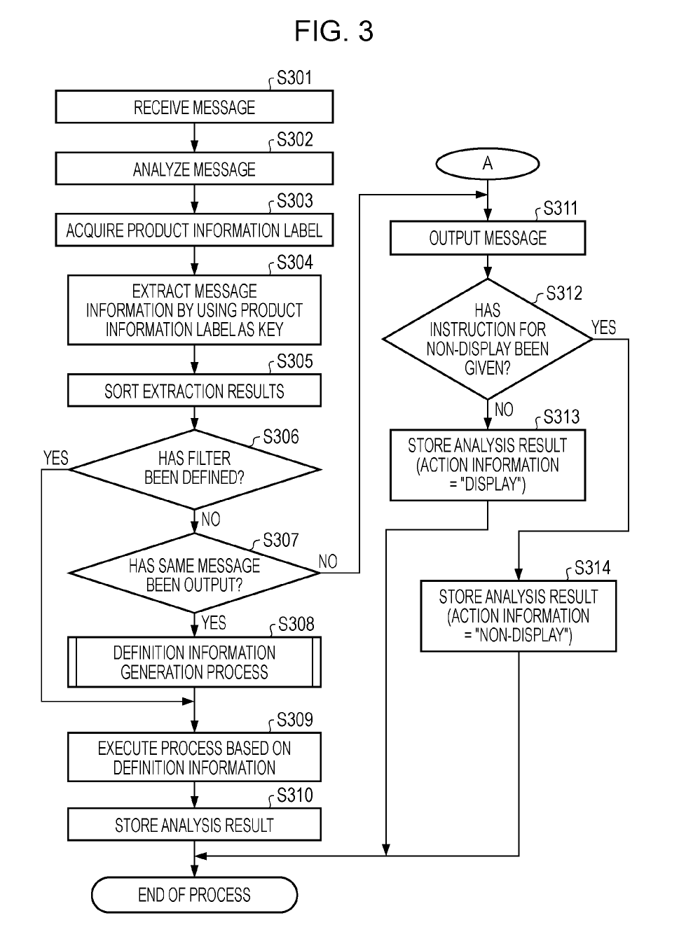

FIG. 3 is a flowchart illustrating a procedure of a process executed by the control apparatus 120. The process executed by the control apparatus 120 according to this embodiment will be described with reference to FIG. 3.

First, when the business server 110 outputs a message during execution of the application, the transmission-reception unit 201 of the control apparatus 120 receives the message output by the business server 110 (S301).

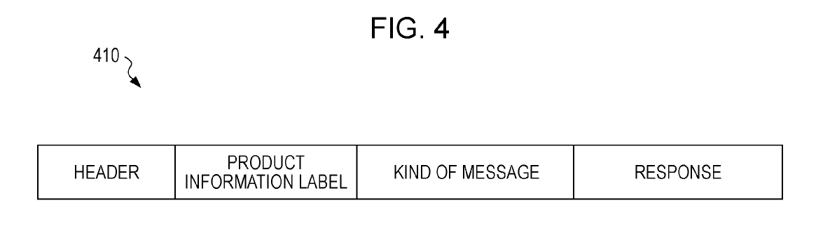

FIG. 4 illustrates an example of a data structure of a message that is output by the business server 110 and is received by the transmission-reception unit 201. As illustrated in FIG. 4, a message 410 output from the business server 110 contains, for example, a header, a product information label, a kind of message, and a response. The header is data containing pieces of information that identify the source of the message, the destination of the message, the data length, the output date and time (the transmission date and time) of the message, and so forth.

After the transmission-reception unit 201 receives the message 410, the analysis unit 202 analyzes the message 410 received by the transmission-reception unit 201 (S302). Specifically, the analysis unit 202 identifies the output date and time of the message from date-and-time information that is attached by the business server 110 when the business server 110 outputs the message. The analysis unit 202 also identifies, from the pieces of information contained in the message 410, pieces of information as follows:
the product information label that indicates a product associated with this message,
the kind of message that indicates what kind of message this message is, and
the response indicating notification contents of this message.

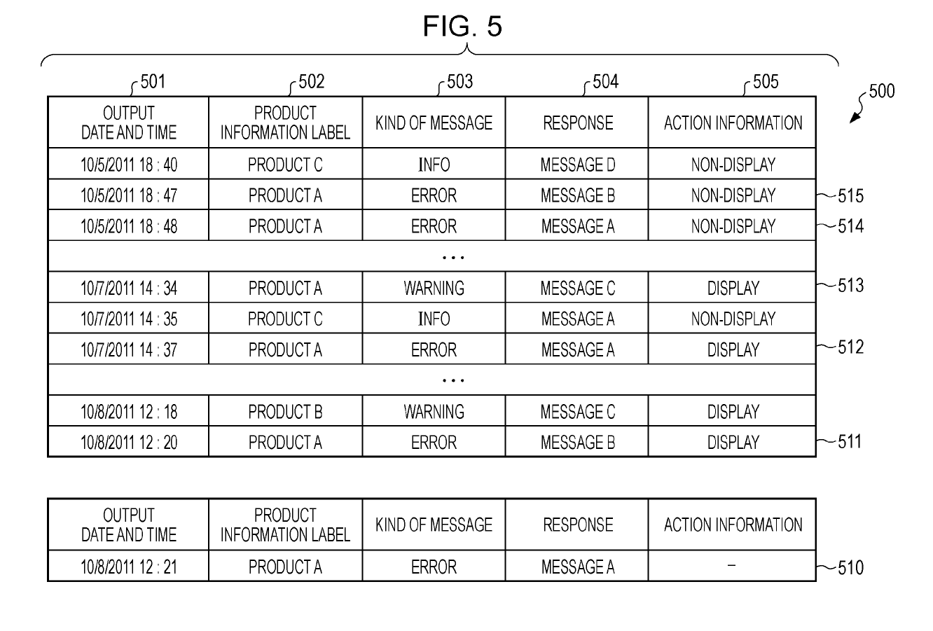

FIG. 5 illustrates an example of the message analysis results. As a result of the processing executed by the analysis unit 202, an output date and time 501, a product information label 502, a kind of message 503, and a response 504 illustrated in FIG. 5 are acquired. The storage processing unit 203 stores the analysis results in the message analysis result DB 211 in steps S310, S313, and S314 described below, whereby the analysis results illustrated in FIG. 5 are stored in the message analysis result DB 211.

Returning now to the description of the flowchart illustrated in FIG. 3, the analysis unit 202 acquires the product information label, which is contained in the received message and is acquired as a result of the analysis performed in step S302 (S303). For example, when a message 510 illustrated in FIG. 5 is received, the analysis unit 202 acquires a “product A” as the product information label.

Then, the extraction unit 204 extracts, from the message analysis result DB 211, message analysis results that contain product information labels that match the product information label acquired by the analysis unit 202 in step S303 (S304). For example, when the “product A” is acquired as the product information label from the received message in step S303, the extraction unit 204 extracts message analysis results 511, 512, 513, 514, and 515 which contain the “product A” as the product information label 502, from among the analysis results 500 stored in the message analysis result DB 211. Even when the control apparatus 120 manages a plurality of kinds of products and applications and even when messages regarding the plurality of kinds of products coexist in the message analysis result DB 211, the use of the product information label allows the extraction unit 204 to extract message analysis results related to the product indicated by the received message. When no product information label is attached to a message because the number of applications executed in the system 100 is one, the control apparatus 120 may omit the processing of steps S303 and S304.

Then in step S305, the extraction unit 204 sorts the messages extracted by the extraction unit 204 in step S304, in the ascending order of the output date and time of the messages (S305). Specifically, the extraction unit 204 rearranges the extraction results in the ascending order of the date and time identified from the output date and time 501 contained in the messages.

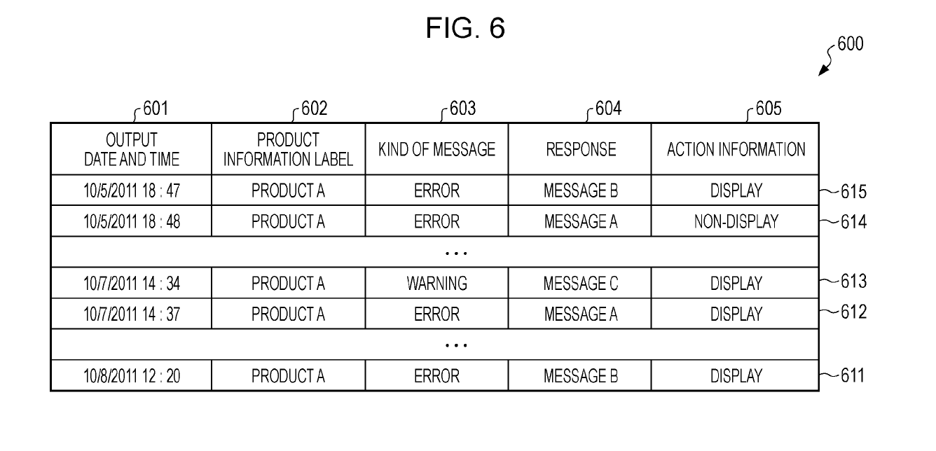

FIG. 6 illustrates a state obtained by sorting the extraction results extracted by the extraction unit 204. An output date and time 601, a product information label 602, a kind of message 603, and a response 604 illustrated in FIG. 6 correspond to the output date and time 501, the product information label 502, the kind of message 503, and the response 504 illustrated in FIG. 5, respectively. Referring to FIG. 6, messages 611, 612, 613, 614, and 615 correspond to the messages 511, 512, 513, 514, and 515 extracted by the extraction unit 204, respectively. When sorting of extraction results is omissible because the extraction unit 204 is capable of extracting messages in the ascending order of the date and time indicated by the output date and time 601 in step S304 or the like, the extraction unit 204 may skip the processing of step S305. The storage processing unit 203 stores the extracted results sorted in step S305 in the extraction result storage unit 212. Here, the storage processing unit 203 may first store the results extracted in step S304 in the extraction result storage unit 212 and the extraction unit 204 may then sort the extraction results stored in the extraction result storage unit 212.

Referring back to the flowchart of FIG. 3, the determination unit 205 determines whether or not “related-message considered processing” is defined for the message received by the transmission-reception unit 201 in step S301 (S306). Details about the “related-message considered processing” and details about the processing of step S306 will be described later.

If the determination unit 205 determines that “related-message considered processing” for the message received by the transmission-reception unit 201 is already stored in the processing definition DB 213, the processing execution unit 207 executes processing based on the “related-message considered processing” that is set for the received message (S309). The storage processing unit 203 then adds, as log information, the analysis result obtained as a result of the processing executed by the analysis unit 202 in step S302 to the message analysis result DB 211 (S310).

On the other hand, if the determination unit 205 determines that “related-message considered processing” for the message received by the transmission-reception unit 201 in step S301 is not stored in the processing definition DB 213, the determination unit 205 determines whether or not a message containing a response that matches the response contained in the message received by the transmission-reception unit 201 in step S301 has been output from the business server 110 (S307). Specifically, the determination unit 205 determines whether or not the extraction results stored in the extraction result storage unit 212 include an extraction result having a response that matches the response contained in the message received by the transmission-reception unit 201 in step S301.

If the determination unit 205 makes positive determination in step S307, the generation unit 206 executes a process of generating definition information, which defines processing for the message, based on the extraction result stored in the extraction result storage unit 212 (S308). After the generation unit 206 executes the process in step S308, the processing execution unit 207 executes processing based on the “related-message considered processing” that is set for the received message (S309). The storage processing unit 203 then adds, as log information, the analysis result obtained as a result of the processing executed by the analysis unit 202 in step S302 to the message analysis result DB 211 (S310). When the analysis result is stored, information that identifies the processing executed by the processing execution unit 207 in step S309 is set as action information.

On the other hand, if the determination unit 205 makes negative determination in step S307, the message received by the transmission-reception unit 201 in step S301 is output to (displayed in) the management client apparatus 130 via the transmission-reception unit 201 (S311). Here, when an instruction for permitting display is input or an instruction for prohibiting display is not input from the input device 135 of the management client apparatus 130 (NO in step S312), the storage processing unit 203 sets “display” as the action information in the analysis result of this received message obtained in step S302. The storage processing unit 203 then adds, as log information, the analysis result having the action information set therein to the message analysis result DB 211 (S313).

Conversely, when the instruction for permitting display is not input or the instruction for prohibiting display is input from the input device 135 of the management client apparatus 130 (YES in step S312), the storage processing unit 203 sets “non-display” as the action information in the analysis result of this received message obtained in step S302. The storage processing unit 203 then adds, as log information, the analysis result having the action information set therein to the message analysis result DB 211 (S314).

As described above, the control apparatus 120 receives a message output by the business server 110, generates definition information for the received message, and executes processing based on the definition information.

Related Message and Definition Information

Now, the “related-message considered processing” mentioned before will be described in detail. In this embodiment, the related message indicates a message that is output by the business server 110 immediately before a message of interest (i.e., the immediately preceding message of the message of interest in the order in which messages are sorted in step S305) among messages regarding the same product. When a specific message is output immediately before the message of interest, outputting the message of interest to the management client apparatus 130 may be avoided by generating a definition that defines processing with the related message being taken into account. Accordingly, in this embodiment, the control apparatus 120 generates “definition information of related-message considered processing” for a message output by the business server 110.

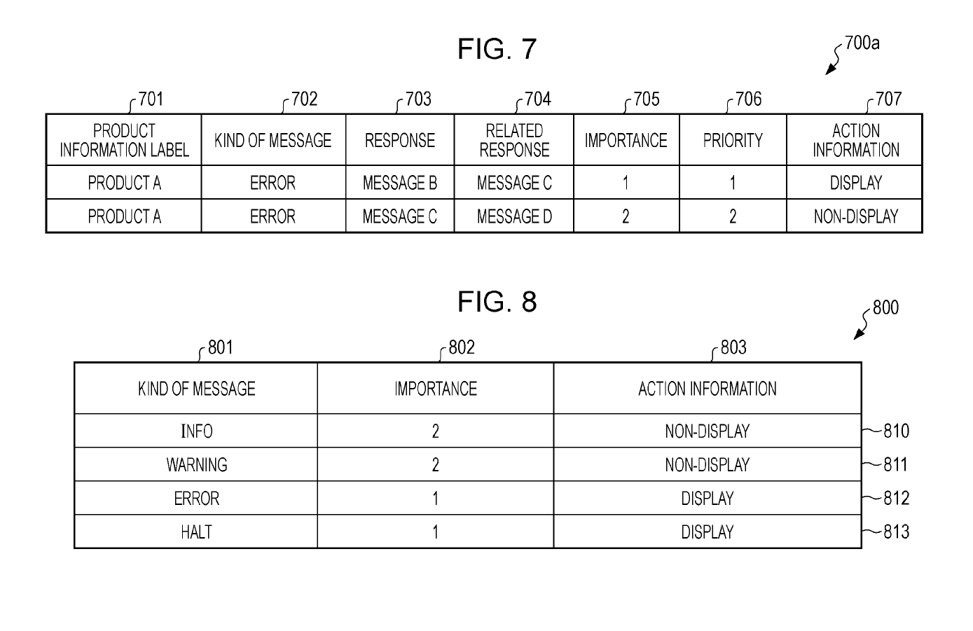

Now, a specific example of the definition information will be described in detail. FIG. 7 is a diagram illustrating an example of a data structure of definition information stored in the processing definition DB 213. Definition information 700a illustrated in FIG. 7 contains a product information label 701, a kind of message 702, a response 703, a related response 704, importance 705, priority 706, and action information 707. The product information label 701, the kind of message 702, and the response 703 may correspond to the product information label 502, the kind of message 503, and the response 504 of the above-described analysis results 500 of the messages, respectively. The related response 704 is information that identifies a response of the related message described before. The importance 705 is an index that expresses how important the response 703 is in operation and management of the system, and is a value that is defined in advance by, for example, the administrator of the system in accordance with the content of the kind of message 702 and that is stored in association with the kind of message 702. The priority 706 indicates which definition information is to be prioritized when a plurality of different pieces of definition information are associated with a certain message.

Now suppose that first definition information defines that processing of displaying a message A is performed upon reception of the message A and second definition information defines that processing of not displaying the message A is performed when the message A is received after a message B. When messages are received in the order of the message B and the message A, both the first definition information and the second definition information are usable. When there are a plurality of pieces of usable definition information, the processing execution unit 207 selects processing based on definition information (e.g., the second definition information) having a higher priority from among the pieces of usable definition information in the processing described later. The action information 707 is information that identifies processing to be executed for the message.

Regarding the importance 705 and the priority 706, the control apparatus 120 may allow the administrator to select the importance and the priority when the definition information is stored in step S308. For example, the control apparatus 120 may display a selection menu on the output device 136 and select the importance and the priority that are selected through an input operation performed using the input device 135.

The importance 705 and the action information 707 described above may be decided by using information stored in the default definition DB 214, for example.

FIG. 8 is a diagram illustrating an example of information stored in the default definition DB 214.

The default definition DB 214 stores information, for example default definition information 800 illustrated in FIG. 8, in which a kind of message 801, importance 802, and action information 803 are associated with each other. FIG. 8 will be described in detail. In default definition information 810, a message whose kind of message 801 is “information (INFO)” is assigned the importance “2” and is assigned a setting in which the control apparatus 120 does “not display” the message in the management client apparatus 130 when this message is received from the business server 110. Also, in default definition information 811, a message whose kind of message 801 is “warning” is assigned the importance “2” and is assigned a setting in which the control apparatus 120 does “not display” the message in the management client apparatus 130 when this message is received from the business server 110. In this embodiment, “information” and “warning” are the kinds of messages output by the business server 110 when the state of the product has changed.

In default definition information 812, a message whose kind of message 801 is “error” is assigned the importance “1” and is assigned a setting in which the control apparatus 120 “displays” the message in the management client apparatus 130 when this message is received from the business server 110. In this embodiment, “error” is the kind of message output by the business server 110 when a failure is detected in operation of the product.

In default definition information 813, a message whose kind of message 801 is “halt” is assigned the importance “1” and is assigned a setting in which the control apparatus 120 “displays” the message in the management client apparatus 130 when this message is received from the business server 110. In this embodiment, “halt” is the kind of message output by the business server 110 when the product stops operating against the intension of, for example, the administrator of the system 100 or the user who uses the product.

Accordingly, when the definition information is stored in step S308, the generation unit 206 may display the candidate importance and the candidate action on the output device 136 with reference to the default definition information 800 to prompt the administrator to confirm whether or not to adopt the displayed candidates. If the administrator adopts the candidates, the generation unit 206 may adopt the candidates. If the administrator does not adopt the candidates, the generation unit 206 may prompt the administrator to input another setting and may adopt the input setting.

Details about Determination Processing in Step S306

The processing performed in step S306 described before will be described in detail. In step S306, the determination unit 205 determines whether or not the “related-message considered processing” is defined for the message received by the transmission-reception unit 201 in step S301.

Specifically, for example, when the message 510 illustrated in FIG. 5 is received, the determination unit 205 determines whether or not definition information that satisfies all the following conditions is stored in the processing definition DB 213.
“Product A” is set as the product information label 701.
“Message A” is set as the response 703.
“Message B” is set as the related response 704.

If definition information that satisfies all these three conditions is stored in the processing definition DB 213, the determination unit 205 determines that the “related-message considered processing” is defined for the message 510. On the other hand, if any of the three conditions is not met, the determination unit 205 determines that “related-message considered processing” is not defined for the message 510.

Details about Definition Information Generation Process

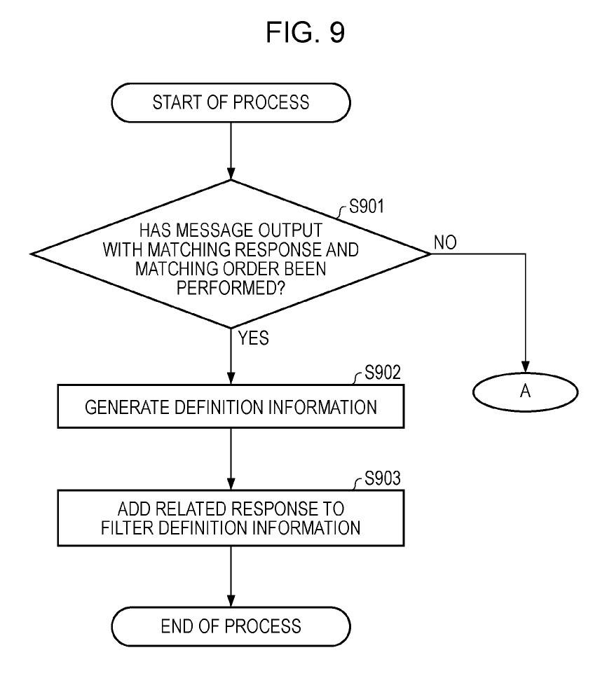

Next, the generation process performed in step S308 described before will be described in detail with reference to FIG. 9.

FIG. 9 is a flowchart illustrating a procedure of definition information generation process executed by the generation unit 206. First, the generation unit 206 determines whether or not messages, which have the same responses as those of the message received by the transmission-reception unit 201 in step S301 of FIG. 3 and a message immediately preceding the received message and which are output in the same order as the received message and the immediately preceding message, have been output (S901). Suppose that the response of the message received this time is, for example, the message A and the response of the message received immediately before is, for example, the message B. The generation unit 206 determines whether or not the extraction results stored in the extraction result storage unit 212 contain analysis results arranged in the order of the response B and the response A.

For example, suppose that the transmission-reception unit 201 receives messages in the order of the message B (the response=message B) and the message A (the response=message A) and that extraction results 600 illustrated in FIG. 6 are stored in the extraction result storage unit 212. In this case, the responses of the analysis results 615 and 614 stored in the extraction result storage unit 212 are the message B and the message A and also the order matches. Thus, positive determination is made in step S901.

If the generation unit 206 makes positive determination in step S901, the generation unit 206 refers to the extraction results stored in the extraction result storage unit 212 and generates definition information that defines the “related-message considered processing” for the message (S902).

The processing performed in step S902 will be described in detail using a specific example. For example, suppose that the generation unit 206 generates definition information when a message whose analysis result is the analysis result 510 illustrated in FIG. 5 is received. The response contained in the analysis result 510 is the message A, and the response of a message output immediately before the message A is the message B based on the extraction result 611 illustrated in FIG. 6. The generation unit 206 refers to an analysis result corresponding to the response A that is included in the extraction results stored in the extraction result storage unit 212 in the order of the response B and the response A. Then, the generation unit 206 identifies the processing content for the message from the action information contained in the analysis result referred to, and generates, for the message, definition information for executing the identified processing.

More specifically, the generation unit 206 sets “product A”, “error”, “message A”, and “non-display” as the product information label 701, the kind of message 702, the response 703, and the action information 707 of the definition information to be generated, respectively.

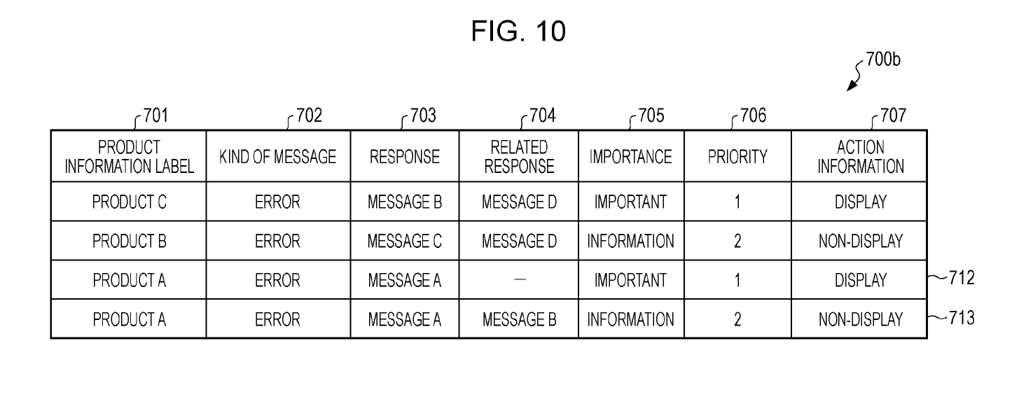

Also, the generation unit 206 sets “message B” as the related response 704 (S903). In this manner, definition information 713 illustrated in FIG. 10 is generated.

After executing the processing of steps S901 to S903, the generation unit 206 terminates the generation process.

When the definition information is generated, the default definition information stored in the default definition DB 214 may be used.

If negative determination is made in step S901, the process proceeds to a connector A illustrated FIG. 3 from a connector A illustrated in FIG. 9. Specifically, the message received by the transmission-reception unit 201 in step S301 is output to (displayed in) the management client apparatus 130 via the transmission-reception unit 201 (S311), and the processing from step S312 illustrated in FIG. 3 is executed.

As a result of the process described above, the generation unit 206 generates definition information for the message received by the transmission-reception unit 201.

Details about Processing in Step S309

The processing performed in step S309 will be described in detail. As described before, the processing execution unit 207 executes processing for the received message based on the definition information stored in the processing definition DB 213.

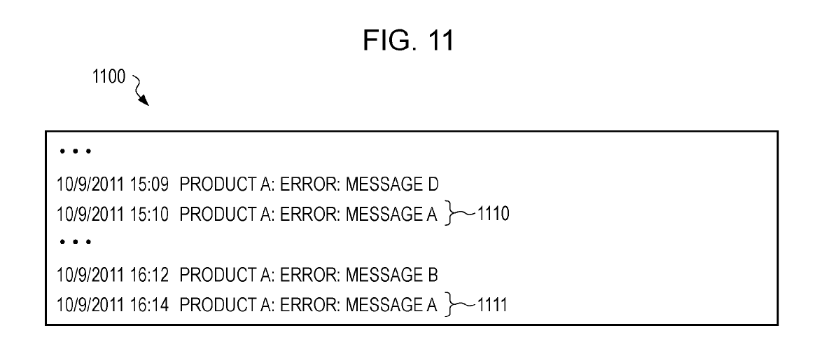

The processing performed in step S309 will be described using a specific example. Assumptions of the specific example used in the description are that definition information 700b illustrated in FIG. 10 is stored in the processing definition DB 213 and that the transmission-reception unit 201 receives messages 1110 and 1111 illustrated in FIG. 11. Here, definition information 712 illustrated in FIG. 10 is definition information that is set in advance by, for example, the administrator of the system 100. The definition information 712 is definition information applied to the message A, for example, when definition information that defines the “related-message considered processing” is not applicable to the message A output from the business server 110.

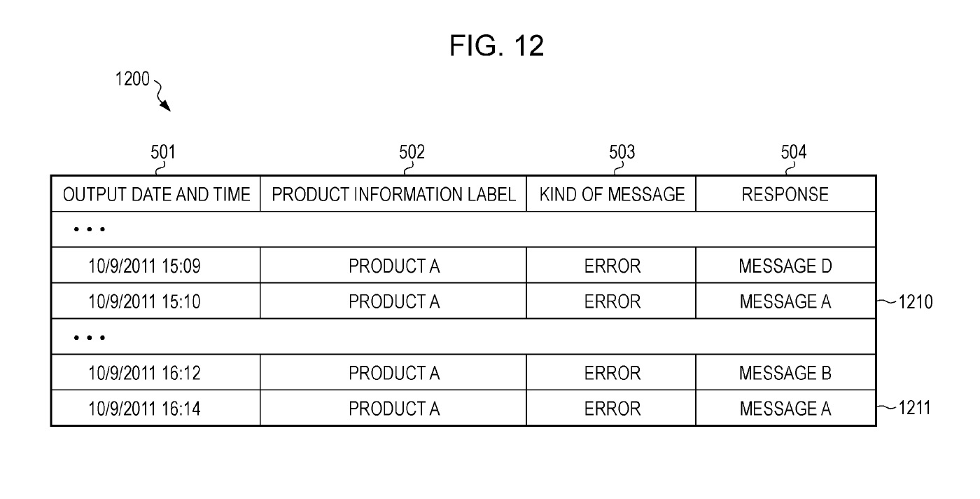

Analysis results 1200 illustrated in FIG. 12 are results obtained by the analysis unit 202 by analyzing messages 1100 illustrated in FIG. 11. Specifically, an analysis result 1210 is a result obtained by the analysis unit 202 by analyzing the message 1110. Also, an analysis result 1211 is a result obtained by the analysis unit 202 by analyzing the message 1111.

Details about Processing Performed when there is No Related Message

First, processing performed for the message 1110 will be described. The analysis result 1210 that is the result obtained by analyzing the message 1110 has the product information label “product A” and the response “message A”. The processing execution unit 207 refers to the processing definition DB 213, which stores the definition information 700b. The definition information 700b contains pieces of definition information 712 and 713 each having the product information label 701 “product A” and the response 703 “message A”.

Here, the processing execution unit 207 refers to the priority 706 of each of the pieces of definition information 712 and 713. The definition information 712 is assigned “1” as the priority 706, whereas the definition information 713 is assigned “2” as the priority 706. Thus, the processing execution unit 207 refers to the definition information 713 having the larger priority value from among the pieces of definition information 712 and 713.

In the definition information 713, the “message B” is set as the related response 704. Here, based on FIG. 12, the response of the message immediately preceding the message 1110 is the message D. Thus, the processing execution unit 207 determines that the definition information 713 is not applicable to the message 1110.

The processing execution unit 207 then refers to the definition information 712, in which the “message A” is set as the response 703 and no information is set as the related response 704. The processing execution unit 207 executes, for the message 1110, processing based on the definition information 712.

In the definition information 712, “display” is set as the action information 707. Accordingly, the processing execution unit 207 outputs the message 1110 to the management client apparatus 130. The management client apparatus 130 having received the message 1110 output by the control apparatus 120 displays the message 1110 on the output device 136.

As described above, as a result of the processing executed by the processing execution unit 207, the message 1110 is displayed on the output device 136 of the management client apparatus 130.

Details about Processing Performed when there is Related Message

Processing performed for the message 1111 will be described. The analysis result 1211 that is the result obtained by analyzing the message 1111 contains the product information label “product A” and the response “message A”. The processing execution unit 207 refers to the processing definition DB 213, which stores the definition information 700b. The definition information 700b contains the pieces of definition information 712 and 713 each having the product information label 701 “product A” and the response 703 “message A”.

Here, the processing execution unit 207 refers to the priority 706 of each of the pieces of definition information 712 and 713. The definition information 712 is assigned “1” as the priority 706, whereas the definition information 713 is assigned “2” as the priority 706. Thus, the processing execution unit 207 refers to the definition information 713 having the larger priority value from among the pieces of definition information 712 and 713.

In the definition information 713, the “message B” is set as the related response 704. Here, based on FIG. 12, the response of the message immediately preceding the message 1111 is the “message B”. Thus, the processing execution unit 207 executes processing based on the definition information 713.

In the definition information 713, “non-display” is set as the action information 707. Accordingly, the processing execution unit 207 does not output the message 1111 to the management client apparatus 130. As a result, the message 1111 is not displayed on the output device 136 of the management client apparatus 130. As a result of the processing executed by the processing execution unit 207, the message 1111 is not displayed on the output device 136 of the management client apparatus 130.

As described above, the embodiment enables the control apparatus 120 to automatically generate definition information while taking into account a message immediately preceding a message to be processed and enables the control apparatus 120 to execute different processing for similar messages based on the generated definition information. Specifically, the messages 1110 and 1111 are messages having the same product information label 502 and the same response 504. However, the message 1111 is not displayed on the output device 136 as a result of the processing executed by the processing execution unit 207. Processing for not displaying a message may reduce a load imposed on the administrator of the system in operation and management of the system, for example.

The configuration described in this embodiment is one of configurations for realizing the embodiment. Contents and procedures of specific processing may be appropriately modified in accordance with the configuration of the system. For example, in the embodiment, the description has been given of an example configuration in which a message is displayed or is not displayed on the display device of the management client apparatus 130 as processing executed for the message. However, various configurations other than the one described in the embodiment are conceivable for the processing executed by the processing execution unit 207. For example, the processing may be processing for executing a command for executing a specific application, such as executing a command for restarting an application that outputs the message in the business server 110. Also, for example, instead of extracting messages from the message analysis result DB 211 by using the product information label 502 as the key by the extraction unit 204, the messages may be classified in advance for each product information label 502 and then be stored in the message analysis result DB 211.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable, non-transitory medium storing therein a control program that causes a computer to execute a procedure, the procedure comprising:
receiving a first message from an information processing apparatus;
searching for a second message in a storage unit in response to reception of the first message, the storage unit storing messages received from the information processing apparatus in a chronological order of the messages, the second message including a same content with a content of the first message;
comparing a third message that is stored in the storage unit prior to the first message, with a fourth message that is stored in the storage unit prior to the second message; and
specifying a processing performed in response to a reception of the second message, when the third message includes a same content with a content of the fourth message, the processing being specified based on information associated with the second message stored in the storage unit.

2. The computer-readable, non-transitory medium according to claim 1,
wherein the procedure further comprises
generating a processing definition specifying that performing the processing in the response of a message, the massage including a same content with a content of the first message and being output from the information processing apparatus after a message including a same content with a content of the third message.

3. The computer-readable, non-transitory medium according to claim 1,
wherein the first message contains product information that identifies a product, and
wherein the storage unit stores messages containing the product information contained in the first message.

4. The computer-readable, non-transitory medium according to claim 2, wherein the procedure further comprises
storing the processing definition in the storage unit.

5. The computer-readable, non-transitory medium according to claim 1, wherein the procedure further comprises
performing the processing in response to the reception of the first message.

6. A control method executed by a computer, the control method comprising:
receiving a first message from an information processing apparatus;
searching for a second message in a storage unit in response to reception of the first message, the storage unit storing messages received from the information processing apparatus in a chronological order of the messages, the second message including a same content with a content of the first message;
comparing a third message that is stored in the storage unit prior to the first message, with a fourth message that is stored in the storage unit prior to the second message; and
specifying a processing performed in response to a reception of the second message, when the third message includes a same content with a content of the fourth message, the processing being specified based on information associated with the second message stored in the storage unit.

7. A control apparatus comprising:
a processor;
a reception unit configured to receive messages from an information processing apparatus;
a storage unit configured to store messages received by the reception unit in a chronological order of the messages; and
a memory storing an instruction executed by the processor, the instruction including:
searching for a second message in the storage unit in response to reception of the first message, the second message including a same content with a content of the first message;
comparing a third message that is stored in the storage unit prior to the first message, with a fourth message that is stored in the storage unit prior to the second message; and
specifying a processing performed in response to a reception of the second message, when the third message includes a same content with a content of the fourth message, the processing being specified based on information associated with the second message stored in the storage unit.
